(19) United States
(12) Patent Application Publication
(10) Pub. No.: US 2021/0317982 A1
(43) Pub. Date: Oct. 14, 2021

(54) FAN LAMP

(71) Applicants: OPPLE LIGHTING CO., LTD., Shanghai (CN); SUZHOU OPPLE LIGHTING CO., LTD., Suzhou City (CN)

(72) Inventor: Jie SHAO, Shanghai (CN)

(73) Assignees: OPPLE LIGHTING CO., LTD., Shanghai (CN); SUZHOU OPPLE LIGHTING CO., LTD., Suzhou City (CN)

(21) Appl. No.: 17/357,911

(22) Filed: Jun. 24, 2021

Related U.S. Application Data
(63) Continuation of application No. PCT/CN2019/128270, filed on Dec. 25, 2019.

(30) Foreign Application Priority Data
Dec. 25, 2018 (CN) 201822184347.2

(51) Int. Cl. F21V 33/00; F21V 3/00; F21S 8/04; F04D 19/00; F04D 29/64

(52) U.S. Cl. CPC F21V 33/0096; F21V 3/00; F04D 29/646; F04D 19/002; F21S 8/04

(57) ABSTRACT

The present disclosure relates to a fan lamp, which includes a base, a first light source module and a fan; the base includes a first side and a second side which are away from each other, a fan groove is formed at the first side, and a first light source setting area is arranged at the second side, an air outlet duct is further arranged on the base and communicated with the fan groove and the second side, and an opening, at the second side, of the air outlet duct surrounds the first light source setting area; the light source module is arranged in the first light source setting area, and the fan is arranged in the fan groove.

### CROSS-REFERENCE TO RELATED APPLICATIONS

This application is based upon and claims the priority of PCT patent application No. PCT/CN2019/128270 filed on Dec. 25, 2019 which claims priority to the Chinese patent application No. 201822184347.2 filed on Dec. 25, 2018, the entire content of both of which is hereby incorporated by reference herein for all purposes.

### TECHNICAL FIELD

The present disclosure relates to the technical field of electric appliances, and particularly relates to a fan lamp.

### BACKGROUND

The lamp is an essential lighting electric appliance in people's life and can provide lighting light for the indoor space at night. The ceiling fan is also a cooling electric appliance which is used for a long time and can be used for cooling in hot summer. The lamp and the ceiling fan need to be arranged on a ceiling, and the working areas of the lamp and the ceiling fan are areas where people often move, so that the arrangement positions conflict.

### SUMMARY

Examples of the present disclosure provide a fan lamp and a method of manufacturing a fan lamp.

An example of the present disclosure provides a fan lamp. The fan lamp may include a base, a first light source module and a fan. The base may include a first side and a second side which are away from each other, a fan groove may be formed at the first side, and a first light source setting area may be arranged at the second side, an air outlet duct may be further arranged on the base and communicated with the fan groove and the second side, and an opening, at the second side, of the air outlet duct may surround the first light source setting area; and the light source module may be arranged in the first light source setting area, and the fan may be arranged in the fan groove.

An example of the present disclosure provides a method of manufacturing a fan lamp. The method may include providing a base, a first light source module and a fan; providing the base with a first side and a second side which are away from each other; forming a fan groove at the first side, and arranging a first light source setting area at the second side, arranging an air outlet duct on the base and communicated with the fan groove, where the second side, and an opening, at the second side, of the air outlet duct may surround the first light source setting area; and arranging the light source module in the first light source setting area, and arranging the fan in the fan groove.

It is to be understood that both the foregoing general description and the following detailed description are exemplary and explanatory only and are not restrictive of the present disclosure.

### BRIEF DESCRIPTION OF THE DRAWINGS

The drawings described here are used to provide a further understanding of the present disclosure and constitute a part of this disclosure. The illustrative examples and description thereof are used to explain the present disclosure, and do not constitute an improper limitation of the present disclosure. In the drawings:

FIG. 1 is a schematic view of a fan lamp disclosed in an example of the present disclosure from a slight upward angle;

FIG. 2 is a schematic view of a fan lamp disclosed in an example of the present disclosure from a slight downward angle;

FIG. 3 is a schematic view of a second side of the base disclosed in the example of the present disclosure;

FIG. 4 is a three-dimensional schematic view of a first side of a base with only one fan disclosed in the example of the present disclosure;

FIG. 5 is a three-dimensional schematic view of a first side of a base provided with a plurality of fans disclosed in the example of the present disclosure;

FIG. 6 is a schematic view of the fan lamp disclosed in the example of the present disclosure from a slight upward angle; and

FIG. 7 is a schematic view of the fan lamp disclosed in an example of the present disclosure from a slight downward angle.

### DETAILED DESCRIPTION

In order to make the purpose, technical solution and advantages of the present disclosure clearer, the technical solution of the present disclosure will be described clearly and completely with reference to examples of the present disclosure and corresponding drawings. The described examples are only a part of the examples of the present disclosure, but not all the examples. Based on the examples in the present disclosure, all other examples obtained by ordinary technicians in the field without creative labor belong to the protection scope of the present disclosure.

Reference numerals used in this disclosure may include:

1—base, 10—fan groove, 100—fan sub-groove, 102—separation blade, 11—first light source setting area, 12—air outlet duct, 120—opening, 122—air deflector, 13—power supply cavity, 14—second light source setting area, 15—fairing ring, 2—fan, 3—first light-transmitting cover, 4—second light-transmitting cover, 5—back cover, 50—air inlet, 52—partition strip.

In order to coordinate the conflict between the lamp and the ceiling fan, a solution of combining the ceiling fan and the lamp has been provided in the related technology. Sometimes, a motor and fan blades of the ceiling fan are generally integrated on a ceiling lamp to form a fan ceiling lamp, and the fan ceiling lamp can be used for lighting and can also supply air.

However, the ceiling lamp is a decorative lamp deviated from European style, and the ceiling lamp occupies a large floor height, so that the ceiling lamp is only suitable for being installed in a building with a high floor height, and is not suitable for being installed in a common house with the floor height of 2.8 m. The motor and the fan blades are further integrated on the basis of the ceiling lamp, so that the floor height occupied by the ceiling lamp is larger, and the ceiling lamp can affect the attractiveness and cause a sense of repression and can also cause potential safety hazards when installed in the common house.

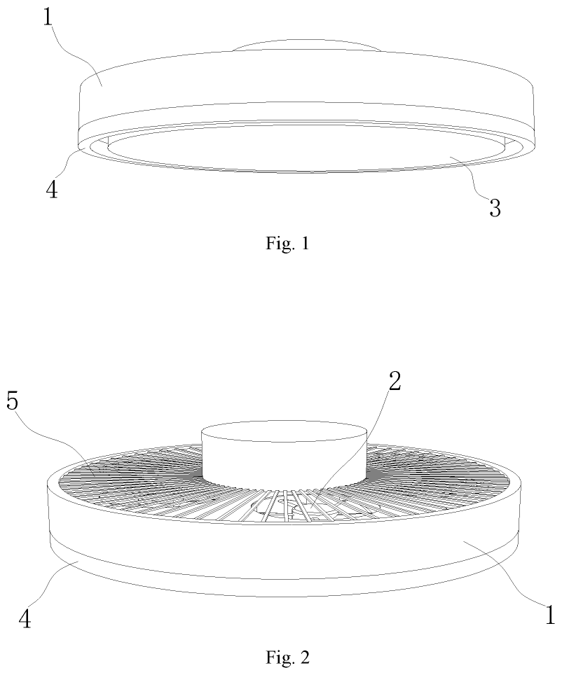

An example of the present disclosure discloses a fan lamp. As illustrated by FIGS. 1 to 6, the fan lamp includes a base 1, a first light source module (not shown in the figure) and a fan 2. The base 1 is a main body structure of the fan lamp and plays a role in fixing and protecting other components.

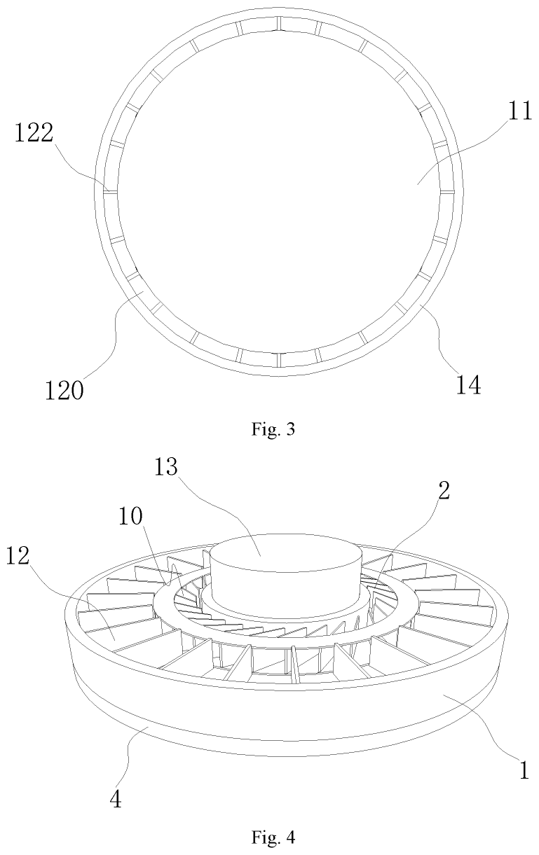

Specifically, the base 1 includes a first side and a second side (not marked in the figure) which are away from each other, the first side includes a fan groove 10, and a first light source setting area 11 (see FIG. 3) is arranged at the second side; and meanwhile, an air outlet duct 12 is further arranged on the base 1 and communicated with the fan groove 10 and the second side, and an opening 120, at the second side, of the air outlet duct 12 surrounds the first light source setting area 11.

The light source module is arranged in the first light source setting area 11, and the fan 2 is arranged in the fan groove 10. Because the fan 2 in the present example is arranged in the fan groove 10, other directions, except the air inlet side, of the fan 2 are relatively closed, the fan can achieve the pressurization effect through such structure, the air inlet amount and the air outlet amount are increased, and therefore no too much distance needs to be reserved between the fan 2 and a ceiling in the example, the overall floor height occupied by the fan lamp can be greatly reduced, the fan lamp is closer to the ceiling and is located at the position where people cannot touch the fan lamp easily, and the repression feeling brought by the lamp is effectively reduced. In addition, because the fan lamp is located at the position where people cannot touch the fan lamp easily, the fan 2 is arranged in the fan groove 10, no blade stretches out in the working state, so that the safety coefficient is higher.

The fan lamp generally includes a drive module (not shown in the figure), and in order to arrange the drive module, the base 1 further includes a power supply cavity 13. The power supply cavity 13 is defined by a solid structure and protrudes out of the first side. In the example, the opening of the power supply cavity 13 is arranged at the second side, and a main body part extends and protrudes from the second side to the first side. Or, the power supply cavity 13 is formed by adopting an outer cover to cover the first side, and the two structures can be selected according to needs.

As illustrated by FIG. 4, in the example, the fan groove 10 can be arranged around the power supply cavity 13 in order to ensure uniform air outlet. Because the fan 2 needs to be fed with air from the opening of the fan groove 10, a groove of the fan groove 10 cannot be clung to the ceiling upon the fan lamp being installed. In order to simplify the installation process, the power supply cavity 13 in the example can exceed the groove of the fan groove 10, so that enough gap for air feeding can be reserved between the groove of the fan groove 10 and the ceiling due to the obstruction of the power supply cavity 13 upon the fan lamp being installed.

In the example, one fan 2 can be adopted, and a plurality of fans 2 can also be adopted simultaneously. As illustrated by FIG. 4, in the case where only one fan 2 is adopted, the fan 2 is a turbofan, and the turbofan is sleeved around the power supply cavity 13 during installing.

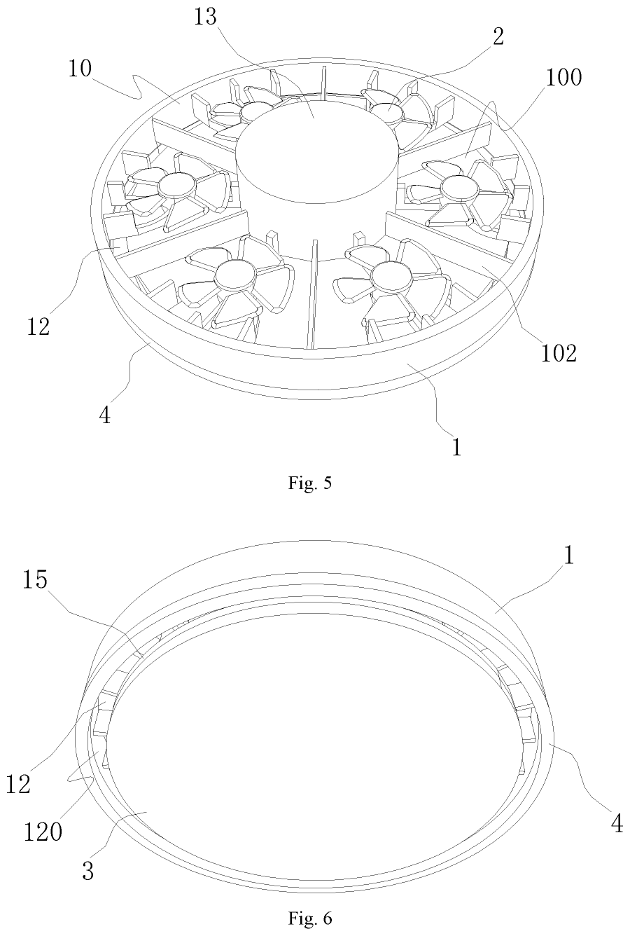

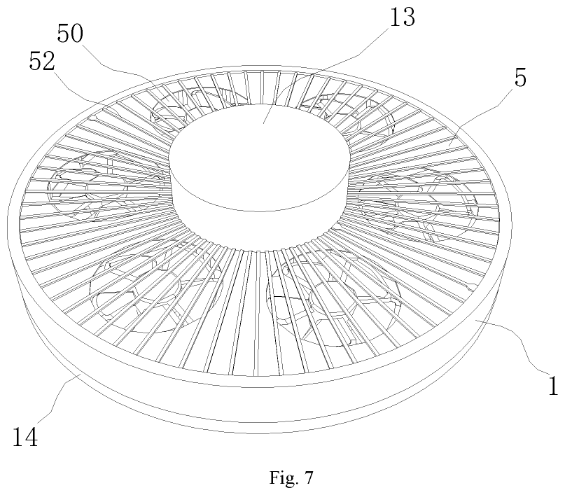

As illustrated by FIG. 5, in the case where the plurality of fans 2 are adopted simultaneously in the example, the fans 2 can be simultaneously arranged in the fan groove 10, but because different fans 2 can generate different air flows, in order to prevent the adjacent fans from interfering with each other, the fan groove 10 is divided into a plurality of independent fan sub-grooves 100, each of the plurality of fan sub-grooves 100 is provided with one of the plurality of fans 2, and the air outlet duct 12 extends to each of the plurality of fan sub-grooves 100 simultaneously. The fan sub-grooves 100 have a plurality of arrangement modes which are mainly designed according to the size of the fan 2 and the structure of the air outlet duct 12. In the example, the fan sub-grooves 100 are preferably arranged along the circumferential direction, and the fan sub-grooves 100 can form a fan-shaped structure, a conch-shaped structure or other structures. The air outlet duct 12 is positioned in the outer side area of the fan-shaped structure, thereby forming a larger air outlet ring.

Two adjacent fan sub-grooves 100 can be separated by a separation blade 102 or other parts, the separation blade 102 can be integrally arranged with the fan groove 10, so that the separation blade is recommended to be adopted.

In the example, in order to enable air blown by the plurality of fans 2 to be blown as a whole, a plurality of air deflectors 122 are uniformly distributed in the air outlet duct 12 along the circumferential direction, the air deflectors 122 can be integrally arranged with the air outlet duct 12 and can also be independently arranged in the form of air guide grooves, and all the air deflectors 122 are obliquely arranged relative to the opening 120 along the same clockwise direction (such as clockwise or anticlockwise). Therefore, the air blown by all the fans 2 can form vortex-shaped disturbance air, the flowing effect of the air can be improved, and the air volume can be increased. Moreover, each fan 2 can be independently matched with different rotating speeds through a driving module, so that the air volume is locally adjusted, the superposition effect is changed, and more air outlet modes are realized.

In the example, common lighting requirements can be met through the first light source module under normal conditions. Along with the improvement of the living standard, people have more requirements on the lighting effect of the lamp. In order to enable the fan lamp to have more diversified lighting effects, the fan lamp in the example can further include a second light source module (not shown in the figure), a second light source setting area 14 is further arranged at the second side, the second light source setting area 14 surrounds the opening 120, and the second light source module is arranged in the second light source setting area 14.

The second light source module can be a light-emitting device with different power or colors from the first light source module. For example, the second light source module can be a low-power light-emitting device, and upon a user only needing low-brightness illumination, the second light source module can be independently turned on. The first light source module can be independently turned on upon the middle brightness being needed. The first light source module and the second light source module can be turned on at the same time upon high brightness being needed, so that the fan lamp has various different brightness modes.

Similarly, in the case the second light source module adopts light-emitting devices with different colors, the user can control the needed light source module to be turned on or off according to needs so as to present different color effects.

As illustrated by the FIG. 5, in the example, a fairing ring 15 can be formed between the first light source setting area 11 and the second light source setting area 14 and is positioned in front of the opening 120. Airflow blown out of the opening 120 can be rectified in the fairing ring 15, the angle of the airflow can be adjusted, and the airflow divided into a plurality of parts by the air deflectors 122 can be integrated into a whole. The extending direction of the fairing ring 15 can face the lower portion and can also incline towards the inner side or the outer side.

In order to adjust the light emitting effect and improve the appearance of the fan lamp, the fan lamp in the example can further include a first light-transmitting cover 3 and a second light-transmitting cover 4, the first light-transmitting cover 3 is matched with the first light source setting area 11 in shape and covers the first light source setting area 11, and the second light-transmitting cover 4 is matched with the second light source setting area 14 in shape and covers the second light source setting area 14. Moreover, the first light-transmitting cover 3 and the second light-transmitting cover 4 in the example can also play a role in prolonging the length of the fairing ring 15.

In the example, a back cover 5 matched with the fan groove 10 in shape can also cover the fan groove 10, as illustrated by FIG. 6, the back cover 5 is provided with an air inlet 50 at the position corresponding to each fan 2, and the rest areas are all sealed, so that, on one hand, the back cover 5 can effectively protect the fans 2 and prevent the user from touching the fans 2. And, on the other hand, the back cover 5 can also improve the air inlet rate to a certain extent.

Furthermore, a plurality of partition strips 52 can also be arranged on aside, away from the fan groove 10, of the back cover 5 at intervals, the arrangement mode of the partition strips 52 is not limited, and the partition strips can improve the structural strength of the back cover 5. When the partition strips extend to the air inlet 50, the partition strips are not segmented, but continue to extend across the air inlet 50, so that a layer of protection net can be formed at the air inlet 50, fingers or other objects of the user are prevented from extending into the air inlet 50, and the safety of the fan lamp is improved.

In conclusion, the fan lamp provided by the example of the present disclosure greatly reduces the occupied space of the floor height and potential safety hazards.

Examples of the present disclose employs the following technical solutions:

An example of the present disclosure provides a fan lamp, which includes a base, a first light source module and a fan;

the base includes a first side and a second side which are away from each other, a fan groove is formed at the first side, and a first light source setting area is arranged at the second side, an air outlet duct is further arranged on the base and communicated with the fan groove and the second side, and an opening, at the second side, of the air outlet duct surrounds the first light source setting area;

the light source module is arranged in the first light source setting area, and the fan is arranged in the fan groove.

Optionally, in the above-mentioned fan lamp, the base further includes a power supply cavity, the power supply cavity protrudes out of the first side, the fan groove is arranged around the power supply cavity, and the power supply cavity exceeds a groove of the fan groove.

Optionally, in the above-mentioned fan lamp, a plurality of fans are provided, and the fan groove is divided into a plurality of independent fan sub-grooves, each of the plurality of fan sub-grooves is provided with one of the plurality of fans, and the air outlet duct extends to each of the plurality of fan sub-grooves.

Optionally, in the above-mentioned fan lamp, the plurality of fan sub-grooves are arranged along a circumferential direction.

Optionally, in the above-mentioned fan lamp, a separation blade is arranged in the fan groove, and two adjacent ones of the plurality of fan sub-grooves are separated by the separation blade.

Optionally, in the above-mentioned fan lamp, the fan is a turbofan, and the turbofan is sleeved around the power supply cavity.

Optionally, in the above-mentioned fan lamp, a plurality of air deflectors are uniformly distributed in the air outlet duct along a circumferential direction, and all of the plurality of air deflectors are obliquely arranged relative to the opening along a same clockwise direction.

Optionally, in the above-mentioned fan lamp, the fan lamp further includes a second light source module, a second light source setting area is further arranged at the second side, the second light source setting area surrounds the opening, and the second light source module is arranged in the second light source setting area.

Optionally, in the above-mentioned fan lamp, a fairing ring is formed between the first light source setting area and the second light source setting area and is positioned in front of the opening.

Optionally, in the above-mentioned fan lamp, the fan lamp further includes a first light-transmitting cover and a second light-transmitting cover, the first light-transmitting cover is matched with the first light source setting area in shape and covers the first light source setting area, and the second light-transmitting cover is matched with the second light source setting area in shape and covers the second light source setting area.

Optionally, in the above-mentioned fan lamp, the fan lamp further includes a back cover, the back cover is matched with the fan groove in shape and covers the fan groove, and the back cover is provided with an air inlet at a position corresponding to the fan.

Optionally, in the above-mentioned fan lamp, a plurality of partition strips are arranged at a side, away from the fan groove, of the back cover at intervals, and a part of the plurality of partition strips extends across the air inlet.

The at least one technical solutions of the examples of the present disclosure can achieve the following favorable effects:

According to the fan lamp disclosed by the example of the application, the fan is arranged in the fan groove to form a pressurization effect to supply air, so that the height of the fan lamp is close to that of the ceiling lamp, and the occupied space in floor height and potential safety hazards are greatly reduced.

The present disclosure also provides a method of manufacturing a fan lamp. The method may include providing a base, a first light source module and a fan; providing the base with a first side and a second side which are away from each other; forming a fan groove at the first side, and arranging a first light source setting area at the second side, arranging an air outlet duct on the base and communicated with the fan groove, where the second side, and an opening, at the second side, of the air outlet duct may surround the first light source setting area; and arranging the light source module in the first light source setting area, and arranging the fan in the fan groove.

The method may also include providing the base with a power supply cavity where the power supply cavity may protrude out of the first side; and arranging the fan groove around the power supply cavity where the power supply cavity may exceed a groove of the fan groove.

The method may include providing a plurality of fans, and dividing the fan groove into a plurality of independent fan sub-grooves; and providing each of the plurality of fan sub-grooves with one of the plurality of fans where the air outlet duct may extend to each of the plurality of fan sub-grooves.

The method may also include arranging the plurality of fan sub-grooves along a circumferential direction. The method may further include arranging a separation blade in the fan groove, and separating two adjacent ones of the plurality of fan sub-grooves by the separation blade.

The present disclosure may include dedicated hardware implementations such as application specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The abovementioned examples of the present disclosure focus on the differences between the various examples. As long as the different optimization features between the various examples are not contradictory, the examples can be combined to form other examples. For the conciseness of the text, there is no more detailed description.

The above are only examples of the present disclosure and are not intended to limit the present disclosure. For those skilled in the art, various modifications and changes on the present disclosure are available. Any modifications, equivalents, improvements, and the like made within the spirit and principle of the present disclosure should be included in the protection ranges of the present disclosure.

What is claimed is:

1. A fan lamp, comprising a base, a first light source module and a fan; wherein:
the base comprises a first side and a second side which are away from each other, a fan groove is formed at the first side, and a first light source setting area is arranged at the second side, an air outlet duct is further arranged on the base and communicated with the fan groove and the second side, and an opening, at the second side, of the air outlet duct surrounds the first light source setting area; and
the light source module is arranged in the first light source setting area, and the fan is arranged in the fan groove.

2. The fan lamp according to claim 1, wherein the base further comprises a power supply cavity, the power supply cavity protrudes out of the first side, the fan groove is arranged around the power supply cavity, and the power supply cavity exceeds a groove of the fan groove.

3. The fan lamp according to claim 2, wherein a plurality of fans are provided, and the fan groove is divided into a plurality of independent fan sub-grooves, each of the plurality of fan sub-grooves is provided with one of the plurality of fans, and the air outlet duct extends to each of the plurality of fan sub-grooves.

4. The fan lamp according to claim 3, wherein the plurality of fan sub-grooves are arranged along a circumferential direction.

5. The fan lamp according to claim 4, wherein a separation blade is arranged in the fan groove, and two adjacent ones of the plurality of fan sub-grooves are separated by the separation blade.

6. The fan lamp according to claim 2, wherein the fan is a turbofan, and the turbofan is sleeved around the power supply cavity.

7. The fan lamp according to claim 1, wherein a plurality of air deflectors are uniformly distributed in the air outlet duct along a circumferential direction, and all of the plurality of air deflectors are obliquely arranged relative to the opening along a same clockwise direction.

8. The fan lamp according to claim 1, wherein the fan lamp further comprises a second light source module, a second light source setting area is further arranged at the second side, the second light source setting area surrounds the opening, and the second light source module is arranged in the second light source setting area.

9. The fan lamp according to claim 8, wherein a fairing ring is formed between the first light source setting area and the second light source setting area and is positioned in front of the opening.

10. The fan lamp according to claim 8, wherein the fan lamp further comprises a first light-transmitting cover and a second light-transmitting cover, the first light-transmitting cover is matched with the first light source setting area in shape and covers the first light source setting area, and the second light-transmitting cover is matched with the second light source setting area in shape and covers the second light source setting area.

11. The fan lamp according to claim 1, wherein the fan lamp further comprises a back cover, the back cover is matched with the fan groove in shape and covers the fan groove, and the back cover is provided with an air inlet at a position corresponding to the fan.

12. The fan lamp according to claim 11, wherein a plurality of partition strips are arranged at a side, away from the fan groove, of the back cover at intervals, and a part of the plurality of partition strips extends across the air inlet.

13. A method of manufacturing a fan lamp, comprising:
providing a base, a first light source module and a fan;
providing the base with a first side and a second side which are away from each other;
forming a fan groove at the first side, and arranging a first light source setting area at the second side, arranging an air outlet duct on the base and communicated with the fan groove, wherein the second side, and an opening, at the second side, of the air outlet duct surrounds the first light source setting area; and
arranging the light source module in the first light source setting area, and arranging the fan in the fan groove.

14. The method of claim 13, further comprising:
providing the base with a power supply cavity, wherein the power supply cavity protrudes out of the first side; and
arranging the fan groove around the power supply cavity, wherein the power supply cavity exceeds a groove of the fan groove.

15. The method of claim 14, further comprising:
providing a plurality of fans, and dividing the fan groove into a plurality of independent fan sub-grooves; and
providing each of the plurality of fan sub-grooves with one of the plurality of fans, wherein the air outlet duct extends to each of the plurality of fan sub-grooves.

16. The method of claim 15, further comprising: arranging the plurality of fan sub-grooves along a circumferential direction.

17. The method of claim 16, further comprising: arranging a separation blade in the fan groove, and separating two adjacent ones of the plurality of fan sub-grooves by the separation blade.
